(19) United States
(12) Patent Application Publication
(10) Pub. No.: US 2005/0130674 A1
(43) Pub. Date: Jun. 16, 2005

(54) Zone where cellular phones can not accept calls

(76) Inventor: Steven Leo Company, Deerfield Beach, FL (US)

Correspondence Address: STEVEN LEO COMPANY, 4371 S.W.10TH PL.#101, DEERFIELD BEACH, FL, 33442, US

(21) Appl. No.: 10/736,148

(22) Filed: Dec. 15, 2003

(51) Int. Cl. H04Q 7/00

(52) U.S. Cl. 455/456.4

(57) ABSTRACT

A radio frequency is transmitted with a limited power for a selected zone. This radio frequency is limited to cellular phones carriers and modulated With random digital data. This digital data alters the digital data transmitted by cellular companies Only in the selected zone where the cellular phone is receiving, This way it will not accept the calls.

### BACKGROUND OF THE INVENTION

There is an increasing use of cellular phones, that in some private or public Places as: libraries, cinemas, banks, etc where calls are in some cases A security issue or not the place to use them.

To this end, radio frequency transceiver controlls them in a selected or desire Zone where cellular phone can not accept calls.

Where the user is force to go out of the zone in case of using his cellular phone.

### SUMMARY OF THE INVENTION.

According to a first aspect of the present invention, there is provided an Radio frequency transceiver (transmitter and receiver).

The receiver polls by receiving radio frequency signals limited only to the Band width for cellular phones.

The active carriers are registered in the eeprom.

According to a second aspect of the present invention, then selected one at a time Modulating together the random digital data and transmitted.

The modulation adds the random digital data to the carriers present in the zone.

### DETAILED DESCRIPTION

The radio frequency transceiver (R.F. transmitter and receiver) The receiver first polls the signals it receives and only registers the ones that Are in the band width of cellular phones, this depends on F.C.C. Regulations (limits)

The poll is done with a electronic cpu that is managed by a microprocessor And the software neccesary to be able to go changing the frequency in the band width and testing the signal that the antenna receives.

This way it tests each frequency in the limits of the band width and the actives ones are register as an address in the eeprom of the cpu board of the R.F. Transceiver.

The cpu and it software does the receiving steps and the transmitting steps At the transmitter steps the following is done, Then the transmitter modulates the carrier with the random digital data And transmits one at a time, with each carrier present in the zone, there can be several carriers in the zone, one for each cellular company.

The cellular phone in the selected zone will demodulate the receiving signal Leaving just the data to read.

As the data for him was altered the call will not be Accepted.

The original data is transmitted by the cellular company at a selected time, this Is altered by the transmitter with the random digital data This way the cellular phone can not accept calls that are for him As the digital data was altered.

The data are bytes of information and random means that the bytes value Between (0-255 decimal) will be changing randomly by the microprocessor at the cpu of the R.F. Transceiver.

This data is digital because each byte contains 8 bits and there value is (1 or 0) 1=high voltage or 0=refernce voltage.

These bits have a decimal value as we told before between (0-255 decimal) depending on each bit of the byte.

This stream of bytes generated by the cpu R.F. Transceiver are the mentioned Random digital data that is modulated with the active carriers and transmitted By the transmitter to the selected zone, this way aletering the stream of data That the original celluar phone company transmits.

As result your cellular phone in the selected zone can not accpet calls, Obtaining this way the security needed in some private or/and public places.

1. An radio frequency transceiver (transmitter and receiver) transmits on Cellular phones carriers modulated with random digital data at low power Just for a selected zone.
Wherein this alters the original digital data transmitted by the cellular companies Just in the selected zone, so the cellular phone can not accept the calls.

2. An radio frequency transceiver according to claim 1, wherein the receiver Polls the band width of cellular phones carriers by receiving their signals And register them as active carriers.

3. An radio frequency transceiver according to claim 2, wherein these active Carriers are selected one at a time and modulated with the random digital Data and transmitted by the transmitter.

4. An radio frequency transceiver according to claim 3,
Wherein the altered digital data in the selected zone can not be accepted by The cellular phone receiver, because once it is demodulated the digital data Is not for that receiver, and the call is not accepted.
